(19) United States
(12) Patent Application Publication
(10) Pub. No.: US 2018/0118941 A1
(43) Pub. Date: May 3, 2018

(54) Asphalt Patch Kit

(71) Applicant: Louis F. Stevens, III, Wolcott, CT (US)

(72) Inventor: Louis F. Stevens, III, Wolcott, CT (US)

(21) Appl. No.: 15/795,520

(22) Filed: Oct. 27, 2017

Related U.S. Application Data
(60) Provisional application No. 62/487,815, filed on Apr. 20, 2017.
(60) Provisional application No. 62/413,732, filed on Oct. 27, 2016.

(51) Int. Cl. C08L 95/00; B65D 51/24; B65D 77/02; B65B 5/04; B65B 7/02; B65B 7/16; B65B 63/08

(52) U.S. Cl. CPC C08L 95/00; B65D 51/242; B65D 77/02; B65B 63/08; B65B 7/02; B65B 7/16; B65B 5/045

(57) ABSTRACT

A kit and method for preparing asphalt for small-scale paving applications. The kit includes a brick of asphalt, an oven bag, and a microwavable container. The method includes placing the brick of asphalt into the oven bag, sealing the oven bag in an airtight manner to prevent the escape of toxic fumes, placing the oven bag into the container, sealing the container, placing the container into a microwave oven, and heating the brick of asphalt in the microwave oven to a temperature sufficient for paving applications.

### CROSS-REFERENCE TO RELATED APPLICATIONS

The present application claims priority to, and incorporates by reference, U.S. Provisional Patent Application No. 62/413,732 filed on Oct. 27, 2016, and U.S. Provisional Patent Application No. 62/487,815 filed on Apr. 20, 2017.

### FIELD OF THE INVENTION

The invention is in the field of asphalt paving. More specifically, the invention relates to kits and methods for preparing asphalt for paving applications.

### BACKGROUND OF THE INVENTION

Asphalt is used for surfacing roads, parking lots, driveways, and floors. Asphalt is widely used in many applications because it offers significant advantages in durability, ease of application, and relative low cost.

As most paving substances, asphalt will degrade over time due to exposure to the elements and use. For example, asphalt driveways will degrade due to vehicle traffic and, in some cases changes in the ground supporting the pavement. This can cause cracks, holes, and other imperfections to form in the pavement. If such imperfections are left untreated, they can cause more rapid deterioration of the pavement and require earlier replacement.

A problem with repairing small imperfections in asphalt paving is that asphalt is often only available from a contractor in large quantities. Given the production and storage requirements for asphalt, it has been considered cost prohibitive for individuals to patch or repair their own driveways and other installations. Further, handling asphalt and preparing it for installation, even to make minor repairs, requires expensive equipment.

Asphalt must be heated in order for it to be applied. This requires use of complicated and often dangerous equipment even for small repair jobs. Further, the heating process is time consuming. These impediments often stand in the way of individuals attempting to make repairs to their own property. This, in turn, requires them to hire expensive contractors for even minor repairs.

What is needed, therefore, is a method and kit that will permit the repair of asphalt paving that is inexpensive and straightforward. Such a method and kit should permit individual homeowners to make repairs themselves and/or permit contractors to offer repairs at much more competitive prices.

### SUMMARY OF THE INVENTION

Accordingly, embodiments of the invention include kits and methods for asphalt installation preparation. In one embodiment of the invention, a kit including a first container, a second container, and a brick of asphalt is provided. The brick of asphalt is adapted to be placed in the second container, the second container is adapted to be placed in the first container, and the first container is adapted to be placed in an oven to heat the brick of asphalt to a temperature sufficient for paving applications.

In some embodiments, the oven is a microwave oven.

In some embodiments, the first container has a rigid structure.

In some embodiments, the kit also includes a lid for sealing the first container. In other embodiments, the lid has at least one handle.

In some embodiments, the first container is formed of cardboard. In other embodiments, the first container is formed of a ceramic material.

In some embodiments, the first container has at least one handle.

In some embodiments, the second container has a flexible structure.

In some embodiments, the kit also includes a sealing member to seal the second container. In some embodiments, the sealing member is interlocking seams. In other embodiments, the sealing member is a tab.

In some embodiments, the second container is formed of a material such as kenylon, nylon, polyester, and polypropylene.

In some embodiments, the brick of asphalt is composed of at least 70 percent by weight of an aggregate formed of one or more of crushed stone, sand, gravel, and slag. In other embodiments, the brick of asphalt is formed of asphalt cement.

In a preferred embodiment of the invention, a kit including a container, an oven bag, and a brick of asphalt is provided. The container has a rigid structure, is formed of cardboard, and is adapted to be heated in a microwave oven. The kit also includes a lid for sealing the container. The oven bag has a flexible structure, a mouth, interlocking seams along the perimeter of the mouth for sealing the oven bag, and is adapted to be placed in the container. The brick of asphalt is composed of at least 70 percent by weight of an aggregate formed of one or more of crushed stone, sand, gravel, and slag. Also, the brick of asphalt is adapted to be placed in the oven bag.

In another embodiment of the invention, a method for preparing asphalt for paving applications is provided. The method includes the steps of placing a brick of asphalt in an oven bag, placing the oven bag in a container, placing the container in a microwave oven, and running the microwave until the asphalt is sufficiently heated to permit its use for paving applications. In some embodiments, the method also includes the step of sealing the oven bag in an airtight manner after the brick of asphalt is placed in the oven bag. In some embodiments, the method also includes the step of sealing the container after the oven bag is placed in the container.

### BRIEF DESCRIPTION OF THE DRAWINGS

FIG. 1 is a perspective view of an asphalt brick according to a first embodiment of the invention.

FIG. 2 is a perspective view of a cardboard container according to a second embodiment of the invention.

FIG. 3 is a perspective view of an oven bag according to a second embodiment of the invention, wherein the oven bag comprises interconnecting members for sealing the oven bag.

FIG. 4 is a perspective view of a patch kit according to a second embodiment of the invention including a brick of asphalt, an oven bag, and a cardboard box.

FIG. 5 is a perspective view of the patch kit of FIG. 4 inside a microwave oven.

FIG. 6a is a perspective view of a ceramic container according to an alternative embodiment of the invention.

FIG. 6b is a perspective view of a lid for the ceramic container of FIG. 6a.

FIG. 7a is a perspective view of a cardboard container according to an alternative embodiment of the invention.

FIG. 7b is a perspective view of a lid for the cardboard box of FIG. 7a.

FIG. 8 is a perspective view of a brick of asphalt inside an oven bag, which is sealed with a tab according to an alternative embodiment of the invention.

### DETAILED DESCRIPTION OF THE INVENTION

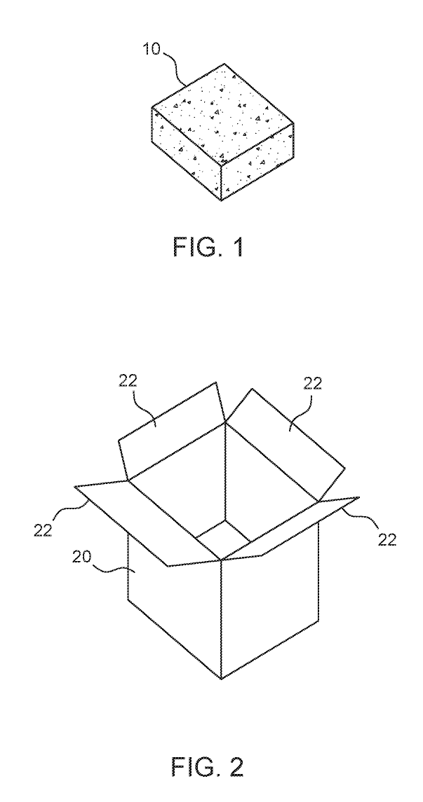

The figures show exemplary embodiments of the invention. In FIG. 1, a brick of asphalt 10 is shown. The brick 10 is generally rectangular and is sized such that individual homeowners can handle and store it without special equipment. In other embodiments, the brick 10 has rounded corners and in still other embodiments, the brick 10 has a different shape, such as a cylinder.

The brick 10 in FIG. 1 is formed of standard asphalt usable for paving roads, parking lots, and driveways. That is, is formed of hot mix asphalt such as a dense-graded mix, a stone matrix asphalt, or an open-graded mix. In a preferred embodiment, the hot mix asphalt is composed of at least 70 percent by weight of aggregate (crushed stone, sand, gravel, slag).

In some embodiments, the hot mix asphalt is composed of 70 to 97 percent by weight of aggregate (crushed stone, sand, gravel, slag) and 3 to 7 percent by weight of petroleum asphalt/bitumen.

In some embodiments, the hot mix asphalt is composed of 70 to 97 percent by weight of aggregate (crush stone, sand, gravel, slag), 3 to 7 percent by weight of petroleum asphalt/bitumen, and 0 to 45 percent by weight of reclaimed asphalt pavement.

In some embodiments, the hot mix asphalt is composed of 70 to 97 percent by weight of aggregate (crushed stone, sand, gravel, slag), 3 to 7 percent by weight of petroleum asphalt/bitumen, 0 to 45 percent by weight of reclaimed asphalt pavement, and 0 to 10 percent by weight of reclaimed asphalt shingles.

In some embodiments, the hot mix asphalt is composed of 70 to 97 percent by weight of aggregate (crushed stone, sand, gravel, slag), 3 to 7 percent by weight of petroleum asphalt/bitumen, 0 to 45 percent by weight of reclaimed asphalt pavement, 0 to 10 percent by weight of reclaimed asphalt shingles, less than 0.5 percent by weight of polymers and natural rubbers, less than 0.1 percent by weight of process oils (inherent in refined petroleum asphalt), less than 0.1 percent by weight of anti-strip or other amine-based additives, and less than 0.1 percent by weight of warm-mix additives. Other asphalt types are used in other embodiments.

In the embodiment of FIG. 1, the brick 10 is 6 inches long, 6 inches wide, and 3 inches high. Of course, in other embodiments, the brick 10 is sized differently.

FIG. 2 shows a container 20 for holding a brick of asphalt (such as the brick 10 of FIG. 1) for heating in a microwave. The container 20 is a cubic cardboard container with flaps 22 at the top for sealing the container 20. The container 20 is 7.750 inches on each side and has a wall thickness of between 0.375″ to 0.500.″

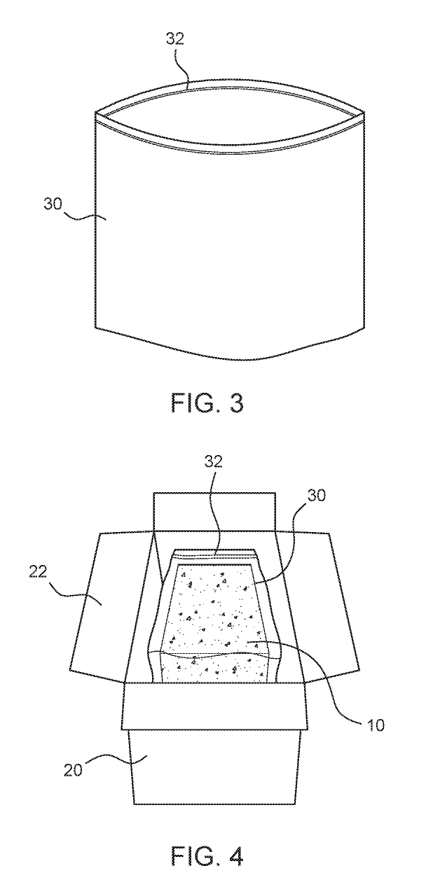

FIG. 3 shows an oven bag 30 for holding the brick of asphalt 10 during heating. Suitable oven bags can be formed from materials such as kenylon, nylon, polyester, and polypropylene. Other types of plastic bag materials are also suitable so long as they seal in any toxic fumes that may be emitted by the asphalt material during heating. The terms “seal,” “sealed,” and “sealing” refer broadly to a range from airtight, hermetic seals to loose seals that merely hinder the escape of gases and other materials from the bag or container. A suitable bag should also be able to withstand temperatures up to 400 degrees Fahrenheit to ensure the safety of the user and that the bag functions as intended.

In some embodiments of the invention, the oven bag 30 comprises a sealing member 32 for sealing the mouth of the bag. Use of a zip lock tab or interlocking seam or other means for sealing the mouth of the bag is preferable. In other embodiments, the oven bag is sealed without the use of a sealing member, such as by tying a knot in the bag near the mouth of the bag. In preferred embodiments, a suitable bag allows for the asphalt material to be heated to its desired temperature of 300-325 degrees Fahrenheit without putting the user's safety in jeopardy.

In the embodiment shown in FIG. 3, the sealing member 32 is formed of interlocking seams, as used in zip lock type bags. In the embodiment shown in FIG. 8, the sealing member 32 comprises a flexible tab that can be tightly wrapped around the oven bag 30. In preferred embodiments, the tab is formed of a material able to withstand temperatures up to 400 degrees Fahrenheit to ensure the safety of the user and that the bag functions as intended.

The container 20 of FIG. 2 is adapted to receive the asphalt brick 10 shown in FIG. 1 inside the oven bag 30 shown in FIG. 3. The interior dimensions of the container 20 are 7″ by 7″ by 7″ so that there is adequate space for the 6″ by 6″ by 3″ asphalt brick 10 sealed within the oven bag 30. The excess space in the container accounts for possible expansion of the brick and any outgassing as a result of heating.

The container 20 of FIG. 2 is formed of a cardboard material that is safe for use in microwave ovens. Such cardboard material is relatively easy and inexpensive to work with and does not interact with the electromagnetic radiation generated by standard microwave ovens (i.e., radiation in the microwave range of the electromagnetic spectrum). Thus, the microwave radiation will interact with the asphalt brick 10 and cause it to be heated. Similarly, the container 20 will not cause harmful or dangerous reflections or focusing of the microwave radiation while the oven is in use.

In the embodiment shown in FIG. 2, the thickness of the walls is between 0.375″ and 0.500″. The wall thickness is selected to permit sufficient strength and resiliency without being so thick as to cause attenuation of the microwave signals on their way to the asphalt brick 10 contained in the container 20.

As mentioned above, in other embodiments, both the brick 10 and the container 20 have a different shape. For example, in another advantageous embodiment, both the container 20 and the brick 10 are cylindrical in shape. In other embodiments, both the container 20 and the brick 10 are cubic. In preferred embodiments, the oven bag 30 is formed of a flexible material to conform to the shapes of the brick 10 and the container 20.

In some embodiments the container is sized such that two containers can fit side-by-side in the microwave oven. In such an embodiment, the user is able to heat double the amount of asphalt without significantly increasing the heating time. This has been found to be preferable in some cases to heating a single larger brick, which can require significantly more heating time.

FIG. 4 shows a preferred embodiment of the asphalt patch kit, wherein an oven bag 30 having interlocking seams sealing member 32 is sealed with an asphalt brick 10 inside of it and placed inside a cardboard container 20. This arrangement is suitable for use as packaging to sell the patch kit, as well as for use in the microwave to heat the asphalt in preparation for creating an asphalt patch.

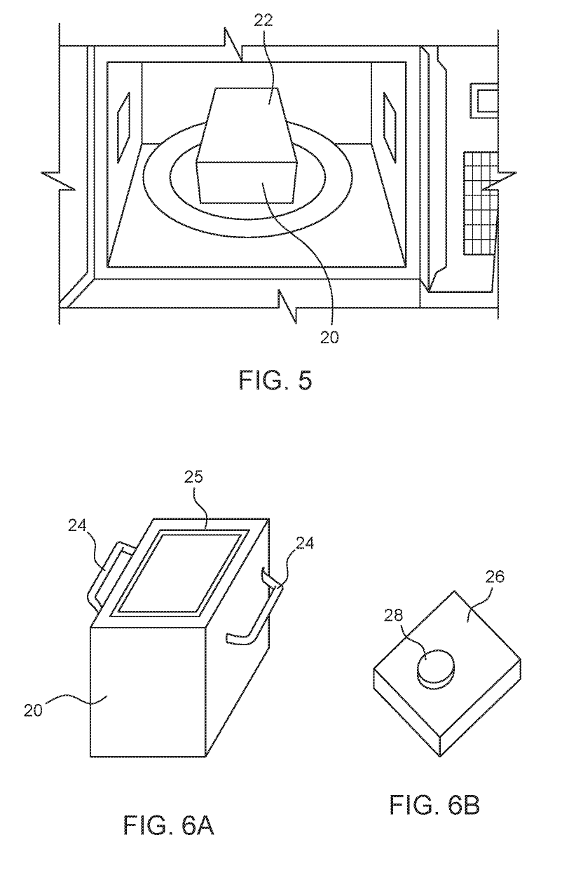

FIG. 5 shows the embodiment of the invention shown in FIG. 4 in condition for heating in the microwave. The cardboard container 20 is closed with the flaps 22 folded inwards and sealed with tape applied along the seam formed by the closed flaps 22. The asphalt patch kit is placed in a microwave oven and is ready to be heated to the desired temperature of the asphalt, which is within the range of 275-325 degrees Fahrenheit.

FIG. 6a shows an alternative embodiment of the invention, wherein the container 20 is a cubic ceramic container with an open top. The container 20 is formed of a ceramic material that is safe and advantageous for use in a microwave oven. In the embodiment shown, the container 20 also includes handles 24 on opposite walls of the container 20. In this embodiment, the container 20 also includes a gasket-style seal 25 around the open top. The seal 25 is formed of a high-temperature rubber in some embodiments (such as silicone rubber). In other embodiments, the seal 25 is formed of a ceramic fiber.

FIG. 6b shows a lid 26 for use with the container 20 of FIG. 6a. The lid 26 is made of the same material as the container 20, i.e., is ceramic. In this embodiment, the lid 26 includes a circular handle 28 near its center which provides for easier lifting of the lid 26 from the container 20. In this embodiments, the lid 26 interacts with the gasket-style seal 25 to seal the interior of the container 20 to prevent fumes from escaping during heating of the asphalt. In some embodiments, the lid's handle has a different shape, such as rectangular.

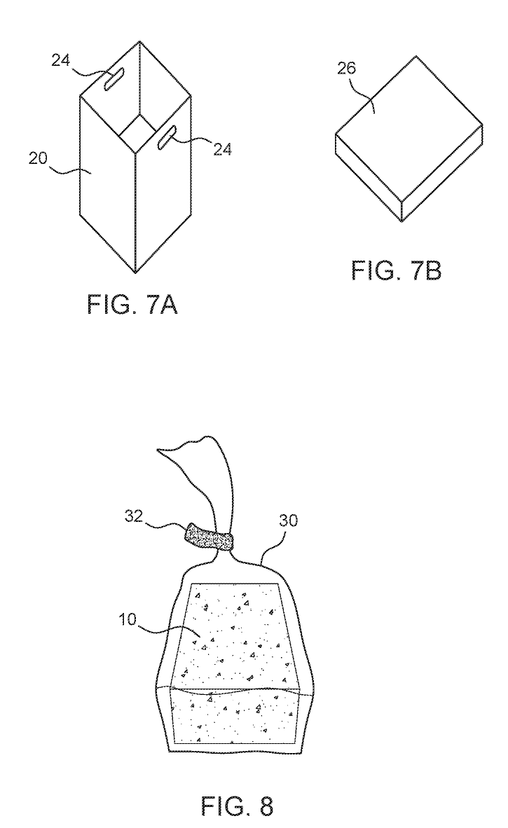

FIG. 7a shows an alternative embodiment of the invention, wherein the container 20 is a cubic cardboard container with an open top. In this embodiment, the container 20 has handles 24 cut out of opposite walls of the container 20. In some embodiments, the container has handles attached to opposite walls of the container. In other embodiments, the container has no handles.

FIG. 7b shows a lid 26 for use with the container 20 of FIG. 7a. The lid 26 is made of the same material as the container 20, i.e., is cardboard. In this embodiment, the lid 26 is separate from the container 20 and has a length and width slightly larger than the length and width of the container 20 such that the lid 26 fits snuggly over the open top of the container 20. In other embodiments, the lid is attached to at least one wall of the container such that the container can be opened or closed by rotating the lid in a hinge-like manner.

According to another embodiment of the invention, a method of preparing asphalt for use is provided. In a first step, an amount of asphalt is placed in an oven bag. In a second step, the oven bag is placed in a microwavable container. In a third step, the container is placed in a microwave oven. In a fourth step, the microwave oven is operated to heat the asphalt.

In some embodiments, the method includes sealing the oven bag in an airtight manner. In some embodiments, the oven bag is formed of a nylon material.

In some embodiments, the method includes placing a microwavable lid on the container to seal the interior of the container. In some embodiments, the microwavable container is formed of a cardboard material. In some embodiments the microwaveable container has a rectangular shape.

In some embodiments, the amount of asphalt is selected such that it occupies less than 50% of the interior volume of the container before heating.

In some embodiments, the container is sized to permit two containers to be heated simultaneously in a microwave oven.

In another embodiment of the invention, instead of an asphalt brick, the kit is used to heat hot liquid asphalt cement. This material is known in the art to be useful for dust control, pavement maintenance, construction chip seal, and cold mix patching. It is known in the art that asphalt cement is easier to work with after being heated.

Those skilled in the art will appreciate variations of the above-described embodiments that fall within the scope of the invention. Thus, the invention is not limited to the specific examples and illustrations discussed above, but only by the following claims and their equivalents.

The following table shows the heating times for various amounts of asphalt placed in an oven bag and cardboard box in microwaves of various powers.

| | Cooking time for: | | | |
|---|---|---|---|---|
| Micro- | Full 7 in × | ¾ 7 in × | Half 7 in × | ¼ 7 in × |
| wave | 7 in Box of | 7 in Box of | 7 in Box of | 7 in Box of |
| Power | Asphalt | Asphalt | Asphalt | Asphalt |
| (Watts) | (20 lbs) | (15 lbs) | (10 lbs) | (5 lbs) |
| 1000 | 23:00 | 17:15 | 11:30 | 5:45 |
| 1100 | 21:00 | 15:45 | 10:30 | 5:15 |
| 1200 | 19:00 | 14:15 | 9:30 | 4:45 |
| 1250 | 18:30 | 13:45 | 9:15 | 4:30 |
| 1300 | 17:30 | 13:00 | 8:45 | 4:15 |

What is claimed is:

1. An asphalt patch kit, comprising:
a first container, a second container, and a brick of asphalt, wherein the brick of asphalt is adapted to be placed in the second container, the second container is adapted to be placed in the first container, and the first container is adapted to be placed in an oven for heating the brick of asphalt to a temperature sufficient for paving applications.

2. The asphalt patch kit of claim 1, wherein the oven is a microwave oven.

3. The asphalt patch kit of claim 1, wherein the first container comprises a rigid structure.

4. The asphalt patch kit of claim 3, wherein the first container further comprises a lid for sealing the first container.

5. The asphalt patch kit of claim 3, wherein the lid further comprises at least one handle.

6. The asphalt patch kit of claim 3, wherein the first container is formed of cardboard.

7. The asphalt patch kit of claim 3, wherein the first container is formed of a ceramic material.

8. The asphalt patch kit of claim 3, wherein the first container further comprises at least one handle.

9. The asphalt patch kit of claim 1, wherein the second container comprises a flexible structure.

10. The asphalt patch kit of claim 1, further comprising a sealing member for sealing the second container.

11. The asphalt patch kit of claim 9, wherein the second container is formed of a material selected from a group consisting of kenylon, nylon, polyester, and polypropylene.

12. The asphalt patch kit of claim 9, wherein the second container is formed of nylon.

13. The asphalt patch kit of claim 10, wherein the sealable member comprises interlocking seams.

14. The asphalt patch kit of claim 10, wherein the sealable member comprises a tab.

15. The asphalt patch kit of claim 1, wherein the brick of asphalt comprises at least 70 percent by weight of an aggregate comprising one or more of crushed stone, sand, gravel, and slag.

16. The asphalt patch kit of claim 1, wherein the brick of asphalt is formed of asphalt cement.

17. An asphalt patch kit, comprising:
a container comprising a rigid structure formed of cardboard, and a lid for sealing the container, wherein the container is adapted to be heated in a microwave oven;
an oven bag comprising a flexible structure, a mouth, and interlocking seams along the perimeter of the mouth for sealing the oven bag, wherein the oven bag is adapted to be placed in the container; and
a brick of asphalt comprising at least 70 percent by weight of an aggregate comprising one or more of crushed stone, sand, gravel, and slag, wherein the brick of asphalt is adapted to be placed in the oven bag.

18. A method of preparing asphalt for paving applications, the method comprising:
packaging a brick of asphalt in an oven bag;
inserting the oven bag in a container;
placing the container in a microwave oven;
heating the brick of asphalt in the microwave oven to a temperature sufficient for paving applications.

19. The method of claim 19 before inserting, further comprising the step of sealing the oven bag in an airtight manner.

20. The method of claim 19 before placing, further comprising the step of sealing the container.
